(19) United States
(12) Patent Application Publication
(10) Pub. No.: US 2002/0144104 A1
(43) Pub. Date: Oct. 3, 2002

(54) Method and system for providing a trusted flash boot source

(76) Inventors: Randall Scott Springfield, Chapel Hill, NC (US); Joseph Wayne Freeman, Raleigh, NC (US)

Correspondence Address: I. B. M. Corp., Intellectual Property Law, Personal and Printing Systems Group, Dept. 9CCA/Bldg. 002-2, P.O. Box 12195, Research Triangle Park, NC, 27709, US

(21) Appl. No.: 09/824,595

(22) Filed: Apr. 2, 2001

(51) Int. Cl. G06F 15/177; G06F 9/00; G06F 9/24

(52) U.S. Cl. 713/2

(57) ABSTRACT

A method and system for evaluating a boot source in a computer system having a processor is disclosed. The method and system include determining the boot source used by the processor each time the computer system boots and allowing the boot source to be specified once as a known boot source. The boot source is determined by storing an identity of the boot source in a first register. The boot source can be specified once as a known boot source in a second register.

### FIELD OF THE INVENTION

The present invention relates to computer systems, and more particularly to a method and system for ensuring that the computer system boots from a trusted source.

### BACKGROUND OF THE INVENTION

FIG. 1 depicts a conventional computer system 10. The computer system 10 includes a processor 12 that runs an operating system 14 for the conventional computer system 10. The conventional computer system 10 also includes a bridge 16 that provides an interface between the processor 12 and other certain components. In particular, the bridge 16 is typically a southbridge that connects the processor 12 with a bus, such as a PCI bus, having one or more connectors 18. The computer system 10 also includes a FLASH boot source 20, coupled with the processor 12 typically through the bridge 16. When the conventional computer system 10 boots up, the FLASH boot source 20 is typically used as the boot source for the processor 12. Once the BIOS has been loaded through booting, the computer system 10 can function normally.

Although the conventional computer system 10 functions in general, one of ordinary skill in the art will readily recognize that the conventional computer system 10 is subject to attack. Although the computer system 10 normally uses the FLASH boot source 20, it is possible to circumvent the FLASH boot source 20 by placing another boot source at the PCI connector 18. If a PCI boot source (not explicitly shown in FIG. 1) is placed at the PCI connector 18, the PCI boot source would be used instead of the FLASH boot source 20. Thus, the computer system 10 would have the BIOS loaded from another, unknown or unwanted boot source. Consequently, an unscrupulous individual could attack the conventional computer system 10. The conventional computer system 10 could be adversely affected by the unknown boot source.

Because the boot source for the conventional computer system 10 can be unknown, the conventional computer system 10 does not have a trusted boot source. A trusted boot source is a boot source that is known and can be verified. A trusted boot source is desired to comply with security requirements, such as those formulated by the trusted client platform association (“TCPA”). It is, therefore, desirable to ensure that the conventional computer system 10 has a trusted boot source. In particular, it would be desirable for the FLASH boot source 20 to be a trusted boot source for the conventional computer system 10.

One mechanism for ensuring that the conventional computer system 10 has a trusted boot source is to preclude the conventional computer system 10 from ever booting off of any source coupled to the PCI connector 18. However, during manufacturing, the FLASH boot source 20 is typically placed into the conventional computer system 10 prior to being programmed. The conventional computer system 10 is then typically booted off of a boot source (not shown) coupled to the PCI connector 18 so that the FLASH boot source 20 can be programmed in place. Preventing any booting from a source connected to the connector 18 would preclude the FLASH boot source 20 from being programmed in place and would alter the way manufacturers must assemble the computer system 10. Consequently, such a solution would be undesirable.

Accordingly, what is needed is a system and method for ensuring that the boot source for the computer system is a trusted boot source. The present invention addresses such a need.

### SUMMARY OF THE INVENTION

The present invention provides method and system for evaluating a boot source in a computer system having a processor. The method and system comprise determining the boot source used by the processor each time the computer system boots and allowing the boot source to be specified once as a known boot source. The boot source is determined by storing an identity of the boot source in a first register. The boot source can be specified once as the known boot source in a second register. The registers are preferably in a bridge coupling the processor to the known boot source.

According to the system and method disclosed herein, the present invention provides a mechanism for ensuring that the boot source is a trusted, known boot source, preferably a FLASH boot source, and checking the boot source to ensure that a trusted source, preferably the FLASH boot source, has been used.

### BRIEF DESCRIPTION OF THE DRAWINGS

FIG. 1 is a block diagram of a conventional computer system.

FIG. 2 is a block diagram of a computer system including a system in accordance with the present invention for providing a trusted boot source.

FIG. 3 is a high-level flow chart of a method in accordance with the present invention for providing a trusted boot source.

FIG. 4 is a more detailed flow chart of a method in accordance with the present invention for providing a trusted boot source.

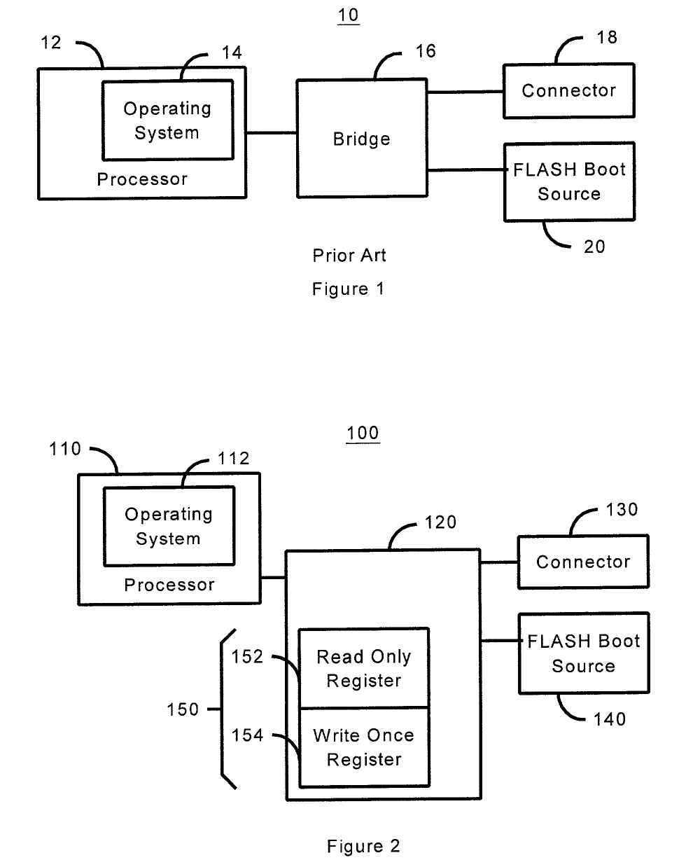

### DETAILED DESCRIPTION OF THE INVENTION

The present invention relates to an improvement in computer system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides method and system for evaluating a boot source in a computer system having a processor. The method and system comprise determining the boot source used by the processor each time the computer system boots and allowing the boot source to be specified once as a known boot source. The boot source is determined by storing an identity of the boot source in a first register. The boot source can be specified once as a known boot source in a second register.

The present invention will be described in terms of a particular computer system having a certain arrangement of components. However, one of ordinary skill in the art will readily recognize that this method and system will operate effectively for other computer systems having different components or a different arrangement of components.

To more particularly illustrate the method and system in accordance with the present invention, refer now to FIG. 2, depicting one embodiment of a computer system 100 utilizing a system 150 in accordance with the present invention for providing a trusted boot source. The computer system 100 thus includes a processor 110 capable of running an operating system 112. The computer system 100 also includes a bridge 120, a connector 130 and an internal boot source 140. For clarity, only a portion of the computer system 100 is depicted. Additional or different components could be used in the computer system 100. The bridge 120 couples the processor 110 with the internal boot source 140 and the connector 130. The bridge 120 could also couple the processor with other components, such as a PCI bus or a USB hub (not shown). The bridge 120 is preferably a southbridge, but could be another bridge. The connector 130 is preferably a PCI connector, but could be another type of connector. The connector 130 can thus be used to connect the computer system 100 to a boot source (not shown) to program the FLASH boot source 140 in place during manufacturing.

The system 150 is shown as being placed in the bridge 120. However, in an alternate embodiment, the system 150 could be placed in another portion of the computer system 100. The system 150 preferably includes a first register 152 and a second register 154. The first register 152 is preferably a read only register that can only be read by the operating system 112. The first register 152 is preferably written to during each boot of the computer system, as described below. However, in a preferred embodiment, the second register 154 can only be written to once.

The first register 152 preferably stores the identity of the boot source used by the computer system 100 for the most recent boot. In a preferred embodiment, the first register 152 performs this function by reporting the source of the first one hundred instructions performed during booting. Thus, the identity of the boot source used by the computer system 100 can be verified by querying the first register 152. The second register 154 stores the identity of a known boot source which the computer system 100 is to use for booting. Preferably, the known boot source whose identity is stored in the second register 154 is to be used for the next boot. Once this identity is written to the second register 154, preferably during manufacturing, all subsequent boots will be from the known boot source. In a preferred embodiment, this known boot source is the FLASH boot source 140. Thus, the system 150 allows for a known, trusted boot source to be provided.

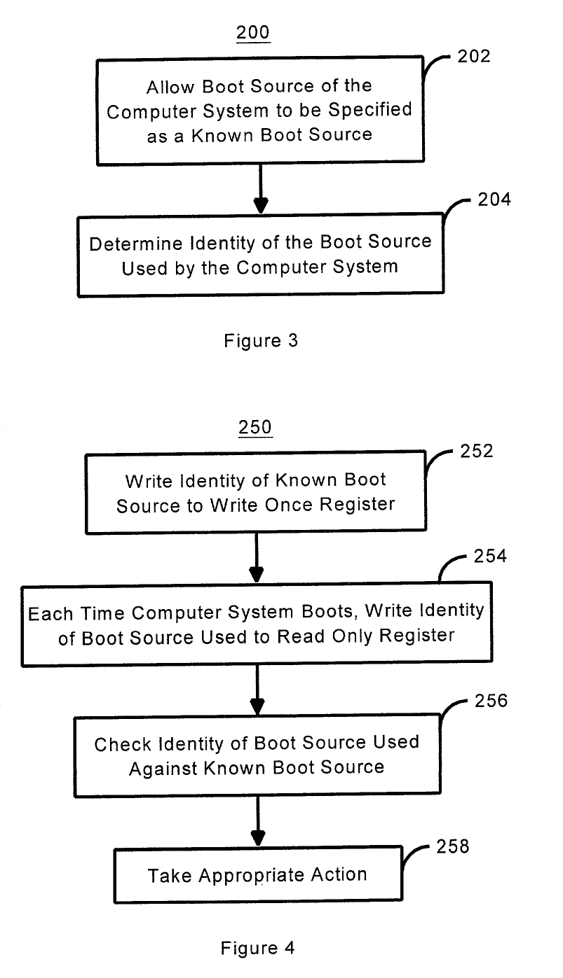

FIG. 3 is a high-level flow chart of a method 200 in accordance with the present invention for providing a trusted boot source. The method 200 is preferably used in conjunction with the system 150 of the computer system 100 depicted in FIG. 2. Consequently, the method 200 will be described in conjunction with the computer system 100. Referring to FIGS. 2 and 3, the boot source to be used by the computer system 100 is specified, via step 202. In a preferred embodiment, step 202 includes writing the identity of the FLASH boot source 140 to the second register 154 a single time. This preferably occurs during manufacturing. As described above, the second register 154 stores the identity of the boot source to be used for the next boot. Thus, once the identity of the FLASH boot source 140 has been stored in the second register 154, the FLASH boot source 140 will be used for all subsequent boots. The identity of the boot source actually used by the computer system 100 in booting up is determined, via step 204. In a preferred embodiment, step 204 includes providing the identity of the source of the first one hundred instructions to the first register 152.

Thus, the method 200 provides a trusted boot source for the computer system 100. When the identity of the FLASH boot source 140 is written to the second register 154, the FLASH boot source 140 is ensured to be the boot source for the computer system 100. Furthermore, the actual boot source used is reported using the first register 152. The use of the FLASH boot source 140 can thus be confirmed by querying the first register 152. Thus, the boot source for the computer system is known (due to the second register 154) and can be verified (using the first register 152). The method 200, therefore, can provide a trusted FLASH boot source 140 for the computer system 100.

FIG. 4 is a more detailed flow chart of a method 250 in accordance with the present invention for providing a trusted boot source. The method 250 is preferably used in conjunction with the system 150 of the computer system 100 depicted in FIG. 2. Consequently, the method 250 will be described in conjunction with the computer system 100. Referring to FIGS. 2 and 4, the identity of the known boot source to be used by the computer system is written a single time to the second register 154, via step 252. Because the second register 154 is a write once register, the boot source written to the second register 154 will be used for all future boots of the computer system 100. In a preferred embodiment, the known boot source written to the second register 154 is the FLASH boot source 140. Each time the computer system 100 boots, the identity of the boot source is written to the first register 152, via step 254. Preferably, step 254 includes providing the identity of the source of the first one hundred instructions executed by the computer system 100 to the first register 152. Because the first register 152 is a read only register, the operating system 112 or other portion of the computer system 100 does not overwrite the identity of the boot source actually used and reported by the first register 152. The operating system then checks the identity of the boot source actually used, via step 256. The operating system queries the first register 152 and can compare the identity stored in the first register 152 to the identity of the FLASH boot source 140. Based on this comparison, the computer system 100 takes appropriate action, via step 258. If the contents of the first register 152 and the second register 154 match, then the computer system 100 continues with normal operation in step 258. If, however, it is determined that the boot source used is not the same as the known boot source indicated in the second register 154, then the computer system 100 may shut down or take other action in step 258.

Thus, the computer system 100 and the method 200 and 250 provide a trusted boot source that is preferably the FLASH boot source 140. The known boot source to be used is specified, preferably in a write once register 154. In addition, the computer system 100 and the methods 200 and 250 can verify the identity of the boot source actually used by the computer system 100, preferably through the use of the first register 152. As a result, a trusted boot source is provided for the computer system 100. This goal is achieved without precluding the FLASH boot source 140 from being programmed in place. Prior to specifying the known boot source to be used in the second register 154, the computer system 100 can boot from a boot source (not shown) coupled to the connector 130. Thus, a trusted FLASH boot source 140 may be provided for the computer system 100 without requiring a significant change in manufacturing of the computer system 100.

A method and system has been disclosed for providing a trusted boot source for a computer system. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for evaluating a boot source in a computer system having a processor comprising the steps of:
(a) determining the boot source used by the processor each time the computer system boots; and
(b) allowing the boot source to be specified once as a known boot source.

2. The method of claim 1 wherein the known boot source ensuring step (b) further includes the step of:
(b1) specifying that the known boot source to be a FLASH boot source.

3. The method of claim 2 wherein the specifying step (b1) further includes the step of:
(b1i) writing an identity of the FLASH boot source in a write-once register which identifies the boot source for future boots.

4. The method of claim 1 wherein the determining step (a) further includes the step of:
(a1) writing an identity of the boot source in a register each time the computer system boots.

5. The method of claim 1 further comprising the step of:
(c) checking the boot source determined in step (a) to ensure that the boot source is the known boot source.

6. A system for evaluating a boot source in a computer system having a processor coupled with a boot source, the system comprising:
a first register for storing an identity of the boot source used by the processor each time the computer system boots; and
a second register for allowing the boot source to be specified once as a known boot source.

7. The system of claim 6 wherein the computer system includes a bridge coupling the processor with the boot source and wherein the first register and the second register are located in the bridge.

8. The system of claim 7 wherein the bridge is a south bridge.

9. The system of claim 6 wherein the known boot source is written only once to the second register.

10. The system of claim 9 wherein the known boot source is a FLASH boot source.

11. The system of claim 6 wherein the identity of the boot source is written to the first register each time the computer system boots.

12. The system of claim 6 wherein the processor is capable of checking the boot source stored in the first register to ensure that the boot source is the known boot source.
